(19) United States
(12) Patent Application Publication
(10) Pub. No.: US 2014/0122096 A1
(43) Pub. Date: May 1, 2014

(54) COMPUTER INTERFACING FOR COMPREHENSIVE AND ANALYTIC SOLUTIONS FOR MEDICAL NETWORKS

(71) Applicant: ORCA HEALTH, INC., Sandy, UT (US)

(72) Inventors: Matthew M. Berry, Highland, UT (US); Chad M. Zeluff, Murray, UT (US); Piers A. Mainwaring, Salt Lake City, UT (US); Dane M. Thurber, Salt Lake City, UT (US)

(73) Assignee: ORCA HEALTH, INC., Sandy, UT (US)

(21) Appl. No.: 13/663,820

(22) Filed: Oct. 30, 2012

(51) Int. Cl. G06Q 50/22

(52) U.S. Cl. 705/2

(57) ABSTRACT

Interfaces and systems are provided to help identify matches between consumer, service and product data and to help notify patients, specialists, product suppliers and other parties about relevant information corresponding to the identified matches. These interfaces and systems can also be used to help track and assist patient progression through various medical treatment cycles. One interface, comprising a smart health card interface, is used to provide updated information to consumers and medical professionals regarding patient data and relevant products and services.

### BACKGROUND OF THE INVENTION

1. The Field of the Invention

This invention generally relates to computer interfaces, as well as systems and methods for utilizing computer interfaces within medical networks. Even more particularly, the present invention relates to methods and systems for utilizing computer interfaces for facilitating analytic matching of consumer, product, and service data, and for tracking and assisting patient progression through medical treatment cycles.

2. The Relevant Technology

The medical community has clearly benefitted from technological and educational advancements which facilitate the development of products and services. These advancements also provide opportunities for medical professionals to become specialized, relative to novel products and services.

Health insurance carriers respond to changes within the medical community by their modifying health care policies to accommodate or exclude coverage for newly developed products and services.

Unfortunately, it can be difficult for consumers to keep track of all of these changes. For instance, it can be difficult for patients to understand and communicate changes in their policy coverage to relevant medical professionals. Many consumers are also unaware of the latest medical advancements and are, therefore, unable to pursue and take advantage of newly developed products and services that could otherwise improve their lives.

The substantial increase in medical advancements and information can also make it somewhat overwhelming for medical professionals to identify the products and services that could have a beneficial impact on their practices and patient experiences.

It can also be difficult for manufacturers to identify specialists and patients to market their products to and that can benefit from their products.

### BRIEF SUMMARY OF THE INVENTION

The present invention provides interfaces and systems that can be utilized to help address some of the foregoing problems experienced in the medical industry. In particular, embodiments of the invention include interfaces and systems that can be used to help identify relevant matches between consumer, service and product data and to help notify patients, specialists, product suppliers and other parties about the relevant matching data.

Embodiments of the invention also include interfaces and systems for helping track and assist patient progression through various medical treatment cycles.

In some embodiments, a smart health card interface is used by computing devices to provide updated information to consumers and medical professionals regarding patient data and relevant products and services.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates one example of a medical network that includes one or more server, patient, specialist and product system;

FIG. 2 illustrates a flowchart of acts associated with methods of the invention;

FIGS. 3a-3c illustrate different examples of smart health card interfaces that can be used to present medial information to patients and industry professionals; and

FIG. 4 illustrates one example of a medical cycle progression chart in which a computer system is used to provide interfacing for facilitating progression through the medical cycle(s).

### DETAILED DESCRIPTION OF THE PREFERRED EMBODIMENTS

Methods, systems and interfaces of the invention can be used to help identify relevant consumer, service and product data and to help notify patients, specialists, suppliers and other relevant parties about the relevant data.

Methods, systems and interfaces of the invention can also be used to help track and assist patient progression through different stages of medical treatment while also providing updated and relevant information to the patients and medical professionals.

Computing Environment

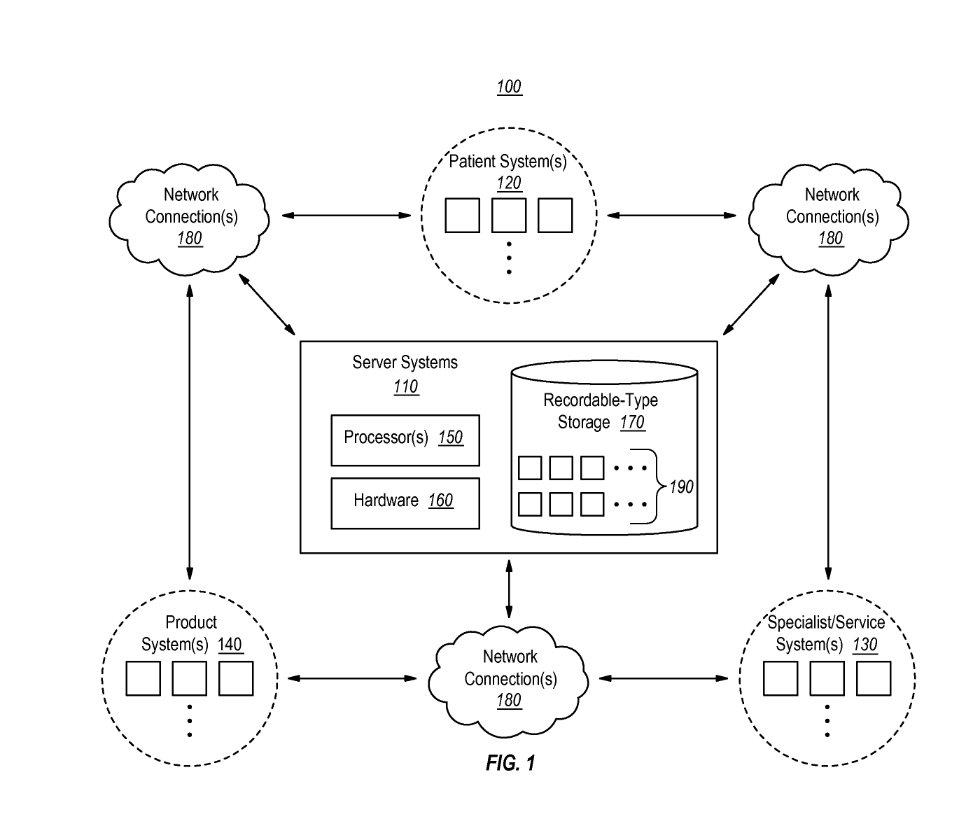

FIG. 1 illustrates one example of a medical network 100 that can utilize aspects of the invention. As shown, the illustrated network 100 includes one or more server system(s) 110, patient system(s) 120, specialist or service system(s) 130 and product system(s) 140.

The server system(s) 110 include one or more hardware processor(s) 150 and other computer hardware 160 (e.g., input devices, output devices and other processing devices), as well as recordable-type computer storage 170.

Each of the illustrated patient system(s) 120, specialist/service system(s) 130 and product system(s) 140, which are presently shown to include three or more different system components, can actually comprise more than three components. These components include corresponding processors, hardware and recordable-type storage, as described with regard to the server system(s) 110.

Each of the illustrated systems (110, 120, 130 and 140) can be restricted to a single computing device or include a plurality of networked devices. These devices can be located in a single location or in multiple locations, such as, for example, within distributed networks and cloud configurations where local and remote computer systems, which are linked (either by hardwired data links, wireless data links, or by a combination of hardwired and wireless data links) through a network, both perform tasks. In a distributed system environment, program modules may be located in both local and remote memory storage devices.

Each of the illustrated systems can comprise one or more consumer device, such as a desktop computer, laptop/notebook computers, message processors, hand-held devices, multi-processor systems, microprocessor-based or programmable consumer electronics, network PCs, minicomputers, mainframe computers, tablets, mobile telephones, PDAs, pagers, routers, switches, servers, kiosk, gaming systems and/or any other computing device.

The consumer device can include a touch-sensitive screen that is utilized to receive user input and to display output associated with the user interfaces of the invention. In other embodiments, keyboards, rollers, touch pads, sticks, mice, microphones and other input devices are used to receive input. Speakers and display screens, which are not touch sensitive, can also be used to render corresponding output.

As shown, the server (110), patient (120), specialist (130) and product (140) systems are all directly or indirectly connected to one or more of the other network systems through a combination of one or more network connection(s) 180. These network connection(s) 180 can include any combination and quantity of hardwire and wireless connections which are well-known to those of skill in the art.

Embodiments within the scope of the present invention also include physical and other computer-readable media for storing computer-executable instructions and/or data structures. Such computer-readable media can include recordable-type storage media 170 or other physical computer storage media (devices) that are distinguished from merely transitory carrier waves or signals.

Computer-readable media that only carry computer-executable instructions and that are not recordable-type media, on the other hand, are transmission media. Thus, by way of example, and not limitation, embodiments of the invention can comprise at least two distinctly different kinds of computer-readable media: computer storage media (presently illustrated as recordable-type storage 170) and transmission media (which can include portions of the network connection(s) 180).

Examples of recordable-type storage media or devices (170) include RAM, ROM, EEPROM, CD-ROM, DVD-ROM, HD-DVD, BLU-RAY or other optical disk storage, magnetic disk storage or other magnetic storage devices, and other recordable-type storage media which can be used to record and store desired program code means in the form of computer-executable instructions and/or data structures which can be accessed and processed by one or more computer processor(s) to implement the methods of the invention.

Computer-executable instructions comprise, for example, instructions and data which, when executed at one or more computing processor 150, cause one or more general purpose computer, special purpose computer, or special purpose processing device to perform a certain function or group of functions. The computer executable instructions may be, for example, binaries, intermediate format instructions such as assembly language, or even source code. Although the subject matter of the invention is described herein with language specific to structural features and/or methodological acts, it is to be understood that the subject matter defined in the appended claims is not necessarily limited to the described features or acts described herein. Rather, the described features and acts are disclosed as example forms of implementing the claims.

Computing Interfaces and Modules

FIG. 1 illustrates how various stored data objects 190 are contained within the recordable-type storage media 170 of the server system(s) 110. In some embodiments, however, these data objects 190 are also contained solely or redundantly within one or more of the other systems of the network 100. The data objects 190 can also be apportioned into separate parts and distributed throughout the network systems. These data objects can include audio and visual files, medical files, indexes, reference materials, user interfaces, computer modules (e.g., computer-executable instructions) and so forth, which are used to present any of the interfaces and the interface data that is displayed by the interfaces of the invention.

In one embodiment, the user interfaces include interactive interfaces that are utilized to display anatomical structures comprising body parts, along with user interface elements that can be selected to facilitate a manipulation and interactive exploration and learning of the displayed anatomical structures.

The user interfaces of the invention can also be utilized to display the anatomical structures after they have been modified relative to a detected or user defined condition and/or treatment. Dynamic perception images can also be displayed to reflect the impact of a selected condition and/or treatment and the various stages of the conditions and treatments. In some embodiments, interface images are blended with camera images captured by a camera connected to the network systems in an augmented reality mode to reflect how a particular condition, treatment or product could appear on an actual living being.

Some interfaces are also provided to enable a user to identify and initiate contact with specialists familiar with the identified anatomical structures and related conditions, treatments and products. These interfaces include interactive elements for enabling a user to communicate with the specialists through email, messaging, VOIP, and so forth.

Some interfaces are also provided to schedule medical appointments or to order medical products, with these interfaces being provided with interactive and selectable elements that enable a patient to select from a plurality of different options and which, when selected, initiate scheduling for a desired medical appointment or which initiate ordering of a listed medical product and which are configured to further send communications to the systems of the medical specialists or product providers to complete the desired appointment scheduling or product ordering.

Interfaces are also provided to further educate patients and consumers regarding the specific procedures and products of interest and that may also be related to a scheduled procedure, as well as to provide preoperative and post-operative education. These interfaces are particularly helpful to ensure that the patients understand what they need to do and what to expect. Accordingly, these interfaces provide instructions and representations of what will occur during a scheduled procedure or subsequent to the procedure. These interfaces also provide interactive elements that, when selected, direct the user to information related to the relevant procedures and products, as well as to provide feedback and input that is used to update the stored medical records associated with the user.

Some interfaces are also provided to notify the patient regarding physical therapy, fitness, dietary and other well-being instructions and regimens and instructions for taking medicine. These interfaces also provide interactive elements for receiving user input regarding the user's fitness and dietary activities, as well as for helping the users identify products and services of interest.

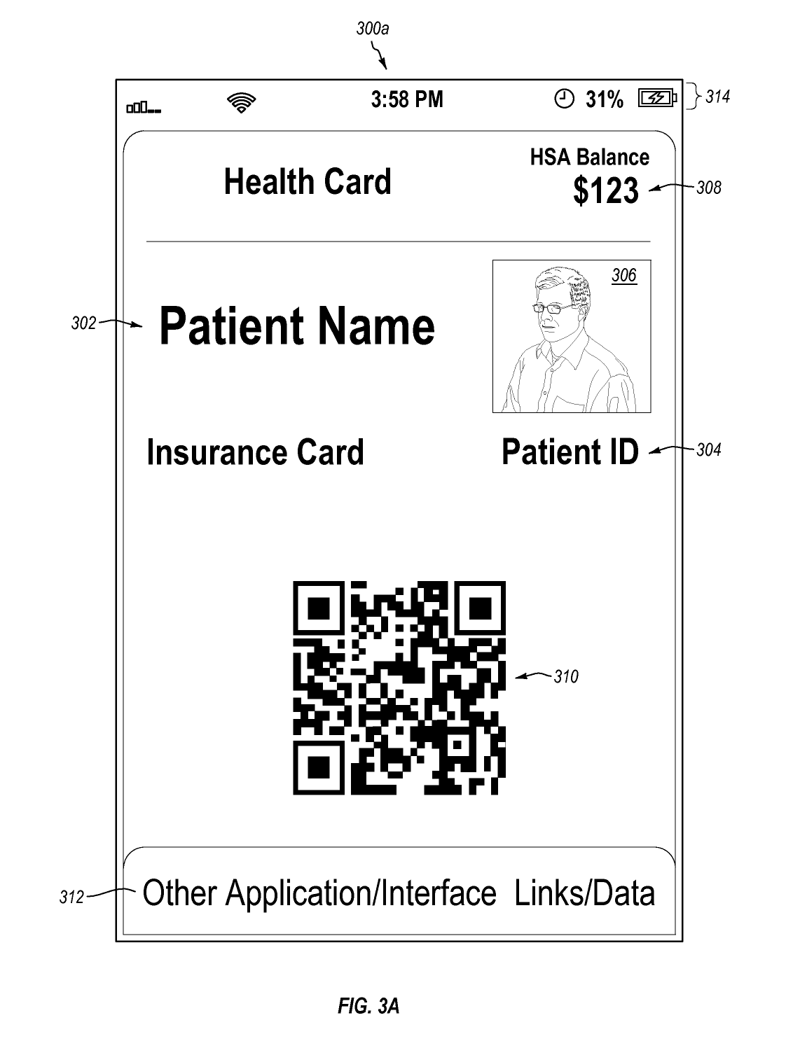

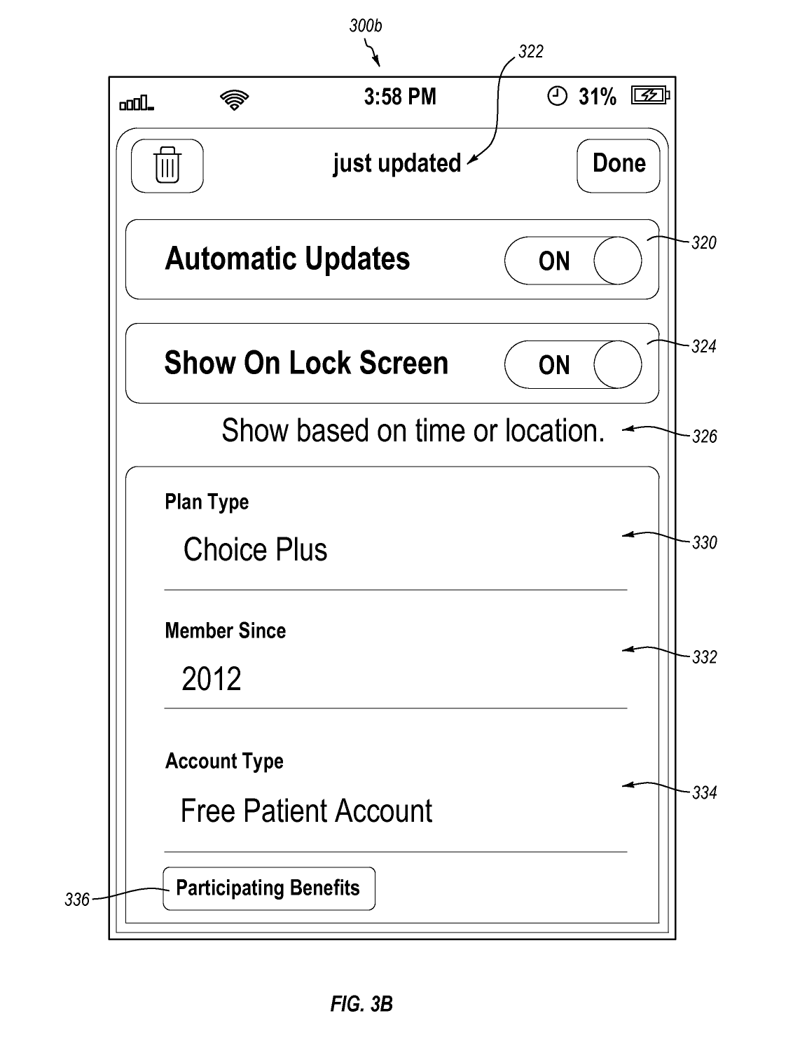

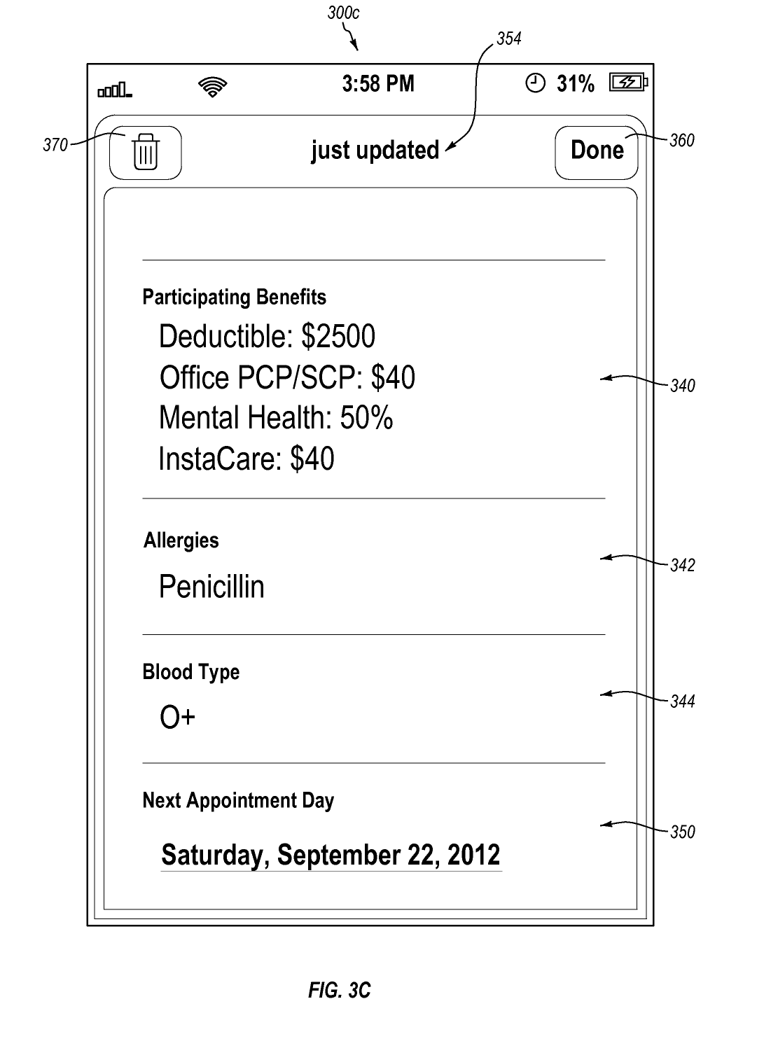

Some smart card interfaces, as described in more detail below, with reference to FIGS. 3a-3c, are also provided to facilitate intake procedures and to provide appropriate medical data and insurance information when needed, as well as any of the other information described herein.

Each of the interfaces (whether located at the server, consumer, specialist or product systems) are interconnected in such a way that they are able to identify changes to the patient, product and specialist data and to provide updated and relevant data at any one of the other systems, when it is determined to be appropriate or needed based on settings in one or more indexes stored by the system.

Computer modules that are included in the data objects 190 and other illustrated system components are operable to filter through the various data stored on the network systems (including medical records, patient data, product data, reference material, appointment inventory, and any other data obtained from the interfaces) to find appropriate and opportunistic matches between the various entities and to facilitate the manner in which a consumer, specialist or product supplier will be notified of relevant data that is obtained from or accessible through one or more of the other systems.

Some of the interfaces that can be utilized by the present invention are disclosed in one or more of the following U.S. Patent Applications, which are all incorporated herein by reference in their entireties, as identified by the following application serial numbers or issued patent numbers: (Ser. No. 13/093,272, Ser. No. 13/167,610, Ser. No. 13/167,600, Ser. No. 13/237,530, and Ser. No. 13/477,794).

Exemplary Methods of the Invention

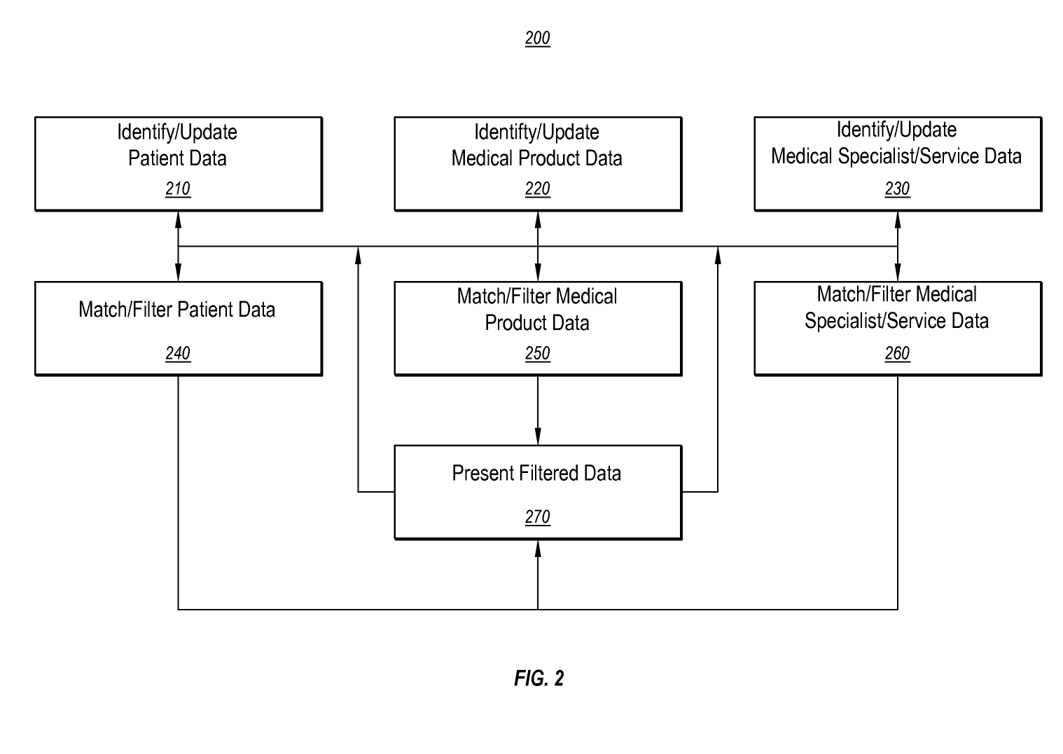

Attention will now be directed to FIG. 2, which illustrates a flow diagram 200 of various acts associated with exemplary methods of the invention for facilitating the creation and identification of matches between consumers, services and products and the identification, filtering, updating and presentation of such information.

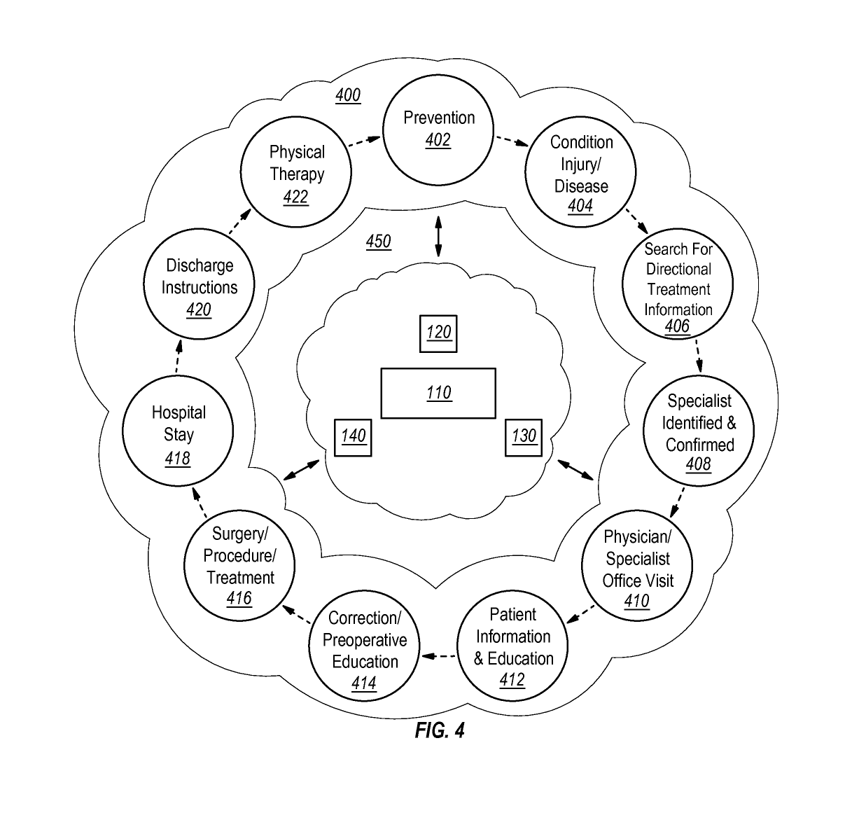

As shown in FIG. 2, the illustrated flow diagram 200 includes acts of identifying and updating patient data (210), medical product data (220), and medical specialist/service data (230). The illustrated acts also include matching and/or filtering the patient data (240), medical product data (250), and medical specialist/service data (260), as well as presenting the filtered data (270). Various embodiments incorporating aspects of the illustrated flow diagram 200 will be described in more detail below with specific reference to FIGS. 3a-4.

In some embodiments, the illustrated acts are performed exclusively at the server system(s) 110. In other embodiments, the illustrated acts are performed partially or exclusively at one of the other network systems (e.g., the consumer, product or specialist systems).

Initially, data associated with a patient, medical product or specialist is identified. This data can include medical records, specialist qualifications, calendar information and contact information, product specifications and other data that is accessible through one or more of the interfaces described or referenced herein and that is stored (190) in one or more recordable-type storage device 170. This data can also include the interfaces themselves.

Periodically, this data (190) is updated according to user input that is entered at one of the network systems. For instance, a user can provide input through an input device in such a way as to modify an interface image or that annotates a record or image or that creates a new record or image. In some instances, updated data is gathered automatically from one or more medical devices that are connected to or that form a part of the patient system. For instance, medical implants and other devices can gather operational data and other metric data that can be used to update existing records and/or displayed presentations (270). Data can also be updated from sensors and other input devices at the specialist or product systems.

The updating of data (210-230) can occur in real-time, responsive to queries (in a pull-scheme) or responsive to data that is pushed to one of the network systems. Once the data is updated at one of the systems, it is preferably updated or made available to each of the other network systems as well.

In one embodiment, the server system 170 receives all updates and pushes out updates and information to the other systems, as determined to be appropriate, such as, for example, upon satisfaction of a predetermined criteria. These predetermined criteria can include a time of day, a location of a device or user, a determination that a financial threshold for a product or service has been met, a determined compatibility or performance of a product, receipt of authorization information, a diagnosis to a patient of a particular condition, a biological indicator, a user query, and/or any other predetermined criteria. The predetermined criteria are set and tracked by the server system in a data structure such as a table or index.

The identified/updated data is indexed and cross-referenced in storage, either manually and/or automatically, with other related data and/or the predetermined conditions. For instance a user or administrator can specify that particular data corresponds directly to other stored data through an interface or through the tagging of data. Automated crawlers and indexing modules can also be applied to automatically parse stored data to identify exact matches to keywords or inferred matches based on contextual interpretations of the parsed data. The data that is parsed can include medical records, audio and image files, annotation records and tags, calendar data, advertisements, product descriptions, insurance records, instruction manuals, reference guides, profile data, and any other stored data.

Parsing, indexing and cross-referencing of data can be performed as part of the matching and filtering processes (240-260).

At any time, upon request or in response to detecting a predetermined condition has been satisfied, the stored data can be filtered to identify matches between the patient, product and specialist data (240-260). Triggers and other executable-instructions are provided in the recordable-type storage 170 to identify and respond to the predetermined conditions.

The matching and filtering of data (240, 250, 160) can include finding a match of product data and/or service data that corresponds to a patient's request or a detected patient condition. Matching can also be performed to find a match between a patient and/or specialist and a product that is being used or that might be of interest. Similarly, matching can include finding a match between a specialist and a patient that a specialist has interacted with or may interact with. Other types of matching can also be performed.

Matching can also include filtering out data. For instance, a pharmacist or physician can receive possible treatment options that have been filtered to exclude medicines or products that a user is determined to be allergic to or that would not be compatible with a particular user. This filtering is performed by the network systems accessing and examining the various data from the user and product systems.

Once a match is found, the data corresponding to the match can be sent to one or more of the network systems to be presented to the relevant/interested parties (270). The matching data can be transmitted over the network connections 180 in an electronic format. Alternatively, matching data can be mailed or shipped to any appropriate party.

The matching data is preferably presented as images and/or audio representations of the matching data. For instance, the data can be presented as pictures, videos and/or audio that is rendered at the patient, product and/or specialist systems within one or more interface, as described and referenced herein.

It will be appreciated that aspects of the flow diagram 200 also support acts for tracking and assisting patient progression through various medical related processes, such as those that are illustrated in the medical cycle 400 shown in FIG. 4.

Attention will now be directed to FIGS. 3a-3c which show non-limiting examples of how smart health card interfaces that can be used to identify and provide the patient, product and specialist data. These interfaces can be presented within an e-wallet, like Google's Wallet, or another collection of interfaces, such as Apple's Passbook, or any other interface tool.

As shown in FIG. 3a, for example, a smart health card interface 300a is configured for displaying patient and product (e.g., insurance data) on a mobile phone or other device. The information from the health card interface 300a can be rendered at the consumer device (e.g., the consumer's mobile phone), at a display device associated with a specialist (e.g., the receptionist's or doctor's computer systems), and/or at a product vender's system (e.g., a pharmacist's computer or the computer of another medical device vendor).

The smart health card interface 300a includes various information (such as patient and insurance information) which can be helpful for a patient, product vender or medical professional during triage of a patient, for purchase of products and services, and during processing of the patient through the various stages of a medical cycle (see FIG. 4).

In the present embodiment, the health card interface 300a includes a patient name 302, and a patient ID 304. The patient ID 304 is an identification number assigned to a consumer by an insurance provider, a medical provider or another product or service provider and which is used to distinguish the consumer from one or more other consumers.

This information can also include a photograph, an icon or other visual identifier 306 associated with the consumer.

In some embodiments, the information provided by the health card interface 300a includes financial information 308, which corresponds to an insurance deductible for the patient, a required co-pay for a scheduled or identified service, a balance due for services performed, a balance remaining for future services/products, or any other type of financial information.

The health card interface 300a also includes a computer-readable link 310, such as a visual linear bar code, matrix code (e.g., (QR) Quick Response code (presently shown)), or other link associated with the interface 300a and which is configured to provide another computing system with access to related patient, medical and/or insurance files through a network connection. The computer-readable link 310 preferably provides network address information, such as a URL or IP address associated with one or more stored computer files.

The access information can also include authorization or authentication information for accessing files that are password locked or secured against unauthorized access. These secured files can include any patient, product or specialist/service files that are included in the stored data objects 190, described above, or that are otherwise accessible with the access information.

In some embodiments, the computer-readable link is not visibly displayed on the interface 300a. Instead, the link comprises a wireless transmission (e.g., an RFID or other transmission) that is provided by RFID hardware or other corresponding hardware within the consumer device and that is selectively activated when the interface 300a is displayed or activated by selection of an interactive object displayed on the interface or a hardware switch on the consumer device. The wireless transmission can also be persistently transmitted or automatically transmitted in response to a predetermined condition, such as upon detecting a particular location of the consumer device or presence of another system/device.

For instance, when a patient walks into a doctor office, the link can activate the transmission of an RFID signal to send patient data or access information for obtaining the patient data to a receiving device at the doctor's office and which is used by the doctor's office computing systems to automatically access and identify information about the patient, including patient records and insurance data, which may or may not be displayed on the health card interface 300a. In other embodiments, the process of accessing and identifying the patient data is performed in response to a doctor office computing system scanning the QR code 310 or other visual link on the health card interface 300a with an appropriate scanner.

The user information can then be used to automatically complete new patient or existing patient visitation records and forms stored on the provider systems, at least partially, without requiring a user and/or receptionist to complete the records manually.

The information provided by the health card interface 300a can also include additional information and links 312, including links to other interfaces or other information specified by an administrator or user.

In some embodiments, the information that is displayed by the interface will automatically be updated or modified based on conditional circumstances. In particular, the satisfaction of a predetermined criteria, such as a detected proximity, a detected time, or other condition (e.g., medical condition or user input), will trigger the display of any of the aforementioned information or additional information, as specified by user/administrator settings that are accessible through menus for the user interfaces described and referenced herein.

Other information corresponding to the display device 314 or other applications can also be displayed with the health card interface 300a. This can be beneficial to reduce the requirement for a user to close the interface 300a in order to access the other information 314 (e.g., wireless signal strength, battery life, time, and so forth).

Any of the information presented by the health card interface 300a can be automatically updated, in real-time, whenever updated information is detected by any of the network systems and in response to the updated information being pushed to the display device (automatically or upon request).

FIG. 3b presents another embodiment of an interface 300b associated with the smart health card and which can be accessed by scrolling the interface 300a image that is shown in FIG. 3a or that can be accessed through the selection of a menu item or link presented in the other application interface links and data (312).

In this embodiment, the interface 300b includes an update control 320 which is selectably operable, when selected by a user, to control whether updates will be automatically pushed to the device or not. When selected for automatic updates, the device will periodically poll for updates from the server system. Selection of the automatic updates can also initiate the sending of an electronic communication to the server system that is operable to request automatic updates. This request, when received, will cause the server system to set a flag or other marker in an index field associated with the consumer device/account and that is used to trigger the server system to send out updates to the consumer device automatically in response to receiving updated data or to, instead, periodically send out any new data according to a predefined schedule.

The update status 322 can be reflected in text and/or by an icon. The update status can also be a hyperlink to controls for selecting the conditions and rules for updating the interface data.

The interface 300b also includes a display control 324 that is selectably controllable, when selected, to control whether a selectable link to the interface (300a, 300b or 300c) will be displayed on another interface display associated with the consumer display device, such as a lock screen interface.

Display criteria 326 can also be displayed to show a user what conditions will result in the interface information being displayed. The display criteria 326 can be static image data or an interactive link to controls for selecting the conditions and rules for displaying different combinations of the interface information. These conditions, which can be tracked at the client device and at the server system can include time, location, presence, medical condition, and/or any other predetermined condition. These conditions, when selected, are used to set corresponding flags or other markers in a data structure such as a table or index at the client device and/or server system for activating triggers and controls to selectively cause different combinations of information to be displayed by the interface.

In one embodiment, a first set of one or more conditions will cause a first set of one or more data items to be displayed while omitting a second set of one or more different data items which are displayed in response to a second set of one or more different conditions.

FIG. 3b illustrates some additional interface information that can be displayed, such as insurance plan information 330, membership data 332, and patient account type 334.

Additional links, such as link 336, can also be provided which will, when selected, access additional information about a patient or a patient's medical records or insurance benefits and coverage. This additional information (as well as any information displayed by the interface) can be cached at the client device or at the server system. In some embodiments, the information displayed on the interface is obtained from a product or specialist system. For instance, by way of example, the computer system at the doctor's office can cache and provide patient medical record data or calendaring data that is sent to and displayed on the patient's device through the interface when the patient is determined to be within a certain proximity to the doctor's office, when the patient's medical records are updated, or when an appointment schedule is approaching.

FIG. 3c illustrates another interface 300c that includes a display of insurance benefits 340 as well as personalized patient information, such as allergies 342 and blood type 344. Other personalized information can also be provided, including physical traits (e.g., weight, height, and so forth), which can be useful when the information is displayed on a specialist or product system to be used in receiving a patient, performing triage, or identifying an appropriate product or medicine for the patient.

Specialist information, such as an appointment schedule 350, or other information can also be displayed on the interface 300c.

Other controls can also be provided along with controls for editing the interface data. These other controls can include a garbage control 370 for deleting information from the interface and a done control 360 for signaling the entry of information or for exiting the interface. When new information is to be added or when information is to be edited, as detected by a user selecting text or by selecting an edit control link (312), a text field can be generated for any of the displayed text to be added or modified. The done control 360 can then be selected to save the changes.

Once changes are made, the update status control 354 can be modified to reflect a current status of the updates that are sent and/or received.

In some embodiments, the smart health card interface(s) provide relevant updated information to consumers and product and service professionals regarding patient data and relevant services and products throughout the different stages of medical treatment cycles, such as the cycle 400 shown in FIG. 4.

According to one embodiment, a different version of the smart health card interface and/or different information and/or interfaces are provided at each of the different stages of the medical treatment cycle, such that the interfaces are dynamically able to provide the most relevant information for a particular stage of a medical cycle. For instance, calendaring information can be provided to a user to schedule an appointment in one stage, while receiving discharge instructions relative to another stage (e.g., post-treatment or after a hospital stay).

Medical Treatment Cycle

FIG. 4 illustrates one example of a medical treatment cycle 400 that includes various stages of patient education and treatment, including prevention 402, condition detection 404, learning 406, specialist identification 408, office visitation 410, follow-up learning 412, and pre-operation/pre-treatment learning 414, treatment/surgery 416, hospital stay 418, post-treatment/post-surgery learning 420, and physical therapy 422. Other stages can also be included in this medical cycle 400. Likewise, some medical cycles will omit one or more of these stages. Regardless of the stages that are included, the present invention includes iteratively performing the acts of FIG. 2 for enabling the network systems 110, 120, 130 and 140 to identify data from the patient, product and service entities and to parse the data and to filter through the parsed data to identify matches of relevant data to present to the entities within the smart card health interface or one or more other interfaces corresponding to the different stages, as appropriate and according to predefined conditions. As shown, this information can be sent to the interfaces through a network connection layer 450 comprising any combination of network connections. This information can be sent on demand, or automatically, in response to detecting a satisfied condition (e.g., updating period, user request, detected environmental condition, and so forth).

During or after a cycle stage occurs, the patient, specialist or product/service supplier can update information related to the cycle stage that is stored and used by the network systems to identify additional relevant information for the user interfaces. This updated information can include annotations, descriptions of activities, prescriptions, treatments or procedures, product updates, or any other information, instructing or informing the user of information relevant to a next stage in the cycle. This information can be automatically and/or manually entered into any one of the network systems. When the updated information is received, new interfaces are created and/or changes to existing interfaces are made by the network system(s) and provided to the other systems for display and use.

By updating and providing information related to the different medical treatment stages, a user can be seamlessly guided completely through the medical cycle with the assistance of the health card interface, for example, while obtaining relevant information via a consistent user interface platform (even though different information is provided on the interface at different stages). For instance, a user can use the health card interface to access relevant information for each new stage that is encountered in the medical cycle. In one embodiment, the system updates and/or changes the information that is displayed with the health card interface each time the system detects the user has entered a new or different stage.

In some embodiments, the relevant information is automatically pushed to and displayed at the health card interface, augmenting or excluding some of the information shown in interfaces 300a, 300b, 300c or other interfaces. In other embodiments, the user is provided a listing of links (which can be updated or remain the same) to other related interfaces for obtaining information or for providing information related to the different medical stages. Some of the other interfaces that can be linked to within the health card interface or that can be provided to track or assist a user progress through a medical treatment cycle include the interfaces described in the following U.S. Pat. Applications and Patents: (Ser. No. 13/093,272, Ser. No. 13/167,610, Ser. No. 13/167,600, Ser. No. 13/237,530, and Ser. No. 13/477,794), including interfaces for exploring and learning about anatomical structures, treatments, conditions, products, specialists and so forth.

In some embodiments, the interface links include specialist or product links (provided as other application interface links and data 312). These links, once selected, present various contact information for the specialists and product suppliers associated with a selected condition, treatment and/or product. Contact interface elements, configured to launch communications with the specialists or product suppliers (when selected), such as email, telephony, instant messaging, and so forth can also be provided in the interface links and data 312. In some embodiments, an advanced search option can be selected to provide a rich query option to filter the search results based on qualifications, specialties, location, tenure, insurance affiliations, referrals, and/or any other filter.

In other embodiments, specialists and product suppliers can also be informed with relevant patient data that is used to perform or provide desired products and services.

In some embodiments, advertisements provided by a specialist or product supplier are selectively sent to only patient devices that correspond to patients that are determined by the network systems to have data (e.g., medical record data and qualifications) matching the available products and services being advertised. These advertisements can be displayed within the other application interface links and data 312.

In one embodiment the methods of the invention are performed by the server system or one of the other network systems perform the following, which also correspond to the general acts illustrated in FIG. 2. First, the system accesses user information related to a user and information related to either a medical product and/or a medical specialist. The system then presents the health card interface with a plurality of data items within corresponding data fields on the interface. The interface is then displayed with data items that are relevant to a plurality of different medical stages of the medical treatment cycle. The system also tracks stages of the medical treatment cycle that the user is participating in and updates at least some of the information on the interface for each of the plurality of different medical stages of the medical treatment cycle. For instance, different combinations of the information from interface 300a, 300b and 300c and other information can be displayed or excluded, depending on the stage of the medical cycle that the user is participating in and depending upon the different conditions that are detected.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for identifying, filtering and presenting data in an electronic user interface, the method being performed by a computing system that includes at least one processor and recordable-type storage, the method comprising:
the computing system accessing user information related to a user;
the computing system accessing information related to either a medical product or a medical specialist;
the computing system presenting a health card interface, the health card interface comprising a plurality of data fields that display a plurality of data items that are relevant to a plurality of different medical stages of a medical treatment cycle;
wherein the health card interface is displayed on at least one user computing device;
the computing system tracking which stage of the medical treatment cycle the user is participating in;
for each of the plurality of different medical stages of the medical treatment cycle, the computing system updating at least some of the information related to the user or the information related to the medical product or medical specialist; and
the computing system detecting different conditions associated with the plurality of different medical stages, wherein the health card interface responsively displays different information for each of the different medical stages having the different conditions.

2. The method of claim 1, wherein the health card interface includes:
at least one selectable control for controlling receipt of updated information; and
at least one selectable control for controlling where a link to the health card interface will be presented relative to the user device.

3. The method of claim 1, wherein the health card interface includes:
at least a first field for displaying a user identification; and
at least a second field for displaying a link that can be scanned to access additional information about the user which is operable to process the user as a patient of the medical specialist or to obtain the medical product.

4. The method of claim 3, wherein the health card interface includes:
at least one field with one or more links to a plurality of interfaces associated with the different stages of the medical cycle.

5. The method of claim 4, wherein the plurality of different stages of the medical cycle include at least the following stages:
prevention, condition detection, specialist identification, pre-operation and/or pre-treatment learning, treatment and/or surgery, and post-treatment and/or post-surgery learning.

6. The method of claim 1, wherein the method further includes:
accessing specialist data from a specialist computing system;
accessing product data from a product computing system;
accessing the user information; and
parsing the specialist data, product data and user information to find matching data between the specialist data, product data and user information and that is also determined to be relevant to one or more predefined conditions.

7. The method of claim 6, wherein the plurality of data items comprise the matching data.

8. A computing system comprising:
at least one processor;
recordable-type storage having stored instructions which, when executed by the at least one processor, implement a method for presenting data in an electronic user interface, the method comprising:
the computing system accessing user information related to a user;
the computing system accessing information related to either a medical product or a medical specialist;
the computing system creating a health card interface, the health card interface comprising a plurality of data fields that display a plurality of data items that are relevant to a plurality of different medical stages of a medical treatment cycle;
wherein the health card interface is sent to and displayed on at least one user computing device;
the computing system tracking which stage of the medical treatment cycle the user is participating in;
for each of the plurality of different medical stages of the medical treatment cycle, the computing system updating at least some of the information related to the user or the information related to the medical product or medical specialist, the updated information being sent to the user computing device; and
detecting different conditions associated with the plurality of different medical stages, wherein the health card interface displays different information for each of the different medical stages having the different conditions.

9. The computing system of claim 8, wherein the health card interface includes:
at least one selectable control for controlling receipt of updated information; and
at least one selectable control for controlling where a link to the health card interface will be presented relative to the user device.

10. The computing system of claim 8, wherein the health card interface includes:
at least a first field for displaying a user identification; and
at least a second field for displaying a link that can be scanned to access additional information about the user which is operable to process the user as a patient of the medical specialist or to obtain the medical product.

11. The computing system of claim 8, wherein the health card interface includes:
at least one field with one or more links to a plurality of interfaces associated with the different stages of the medical cycle.

12. The computing system of claim 11, wherein the plurality of different stages of the medical cycle include at least the following stages:
prevention, condition detection, specialist identification, pre-operation and/or pre-treatment learning, treatment and/or surgery, and post-treatment and/or post-surgery learning.

13. The computing system of claim 8, wherein the method further includes:
accessing specialist data from a specialist computing system;
accessing product data from a product computing system;
accessing the user information; and
parsing the specialist data, product data and user information to find matching data between the specialist data, product data and user information and that is also determined to be relevant to one or more predefined conditions.

14. The computing system of claim 13, wherein the plurality of data items comprise the matching data.

15. A recordable-type storage having stored instructions which, when executed by the at least one processor, cause a computing system to implement a method for presenting data in an electronic user interface, the method comprising:
the computing system accessing user information related to a user;
the computing system accessing information related to either a medical product or a medical specialist;
the computing system creating a health card interface, the health card interface comprising a plurality of data fields that display a plurality of data items that are relevant to a plurality of different medical stages of a medical treatment cycle;
wherein the health card interface is sent to and displayed on at least one user computing device;
the computing system tracking which stage of the medical treatment cycle the user is participating in;
for each of the plurality of different medical stages of the medical treatment cycle, the computing system updating at least some of the information related to the user or the information related to the medical product or medical specialist, the updated information being sent to the user computing device; and
detecting different conditions associated with the plurality of different medical stages, wherein the health card interface displays different information for each of the different medical stages having the different conditions.

16. The recordable-type storage of claim 15, wherein the health card interface includes:
at least one selectable control for controlling receipt of updated information; and
at least one selectable control for controlling where a link to the health card interface will be presented relative to the user device.

17. The recordable-type storage of claim 15, wherein the health card interface includes:
at least a first field for displaying a user identification; and
at least a second field for displaying a link that can be scanned to access additional information about the user which is operable to process the user as a patient of the medical specialist or to obtain the medical product.

18. The recordable-type storage of claim 15, wherein the health card interface includes:
at least one field with one or more links to a plurality of interfaces associated with the different stages of the medical cycle.

19. The recordable-type storage of claim 15, wherein the plurality of different stages of the medical cycle include at least the following stages:
prevention, condition detection, specialist identification, pre-operation and/or pre-treatment learning, treatment and/or surgery, and post-treatment and/or post-surgery learning.

20. The recordable-type storage of claim 19, wherein the method further includes:
accessing specialist data from a specialist computing system;
accessing product data from a product computing system;
accessing the user information; and
parsing the specialist data, product data and user information to find matching data between the specialist data, product data and user information and that is also determined to be relevant to one or more predefined conditions,
wherein the plurality of data items comprise the matching data.
